(19) United States
(12) Patent Application Publication
(10) Pub. No.: US 2007/0128566 A1
(43) Pub. Date: Jun. 7, 2007

(54) Heat exchanger for rotary kilns

(76) Inventors: Lee R. Whaley, Pittsburgh, PA (US); Albert L. Renkey, McMurray, PA (US)

Correspondence Address: Thomas C. Wettach, Esq.;Cohen & Grigsby, P.C., 15th Floor, 11 Stanwix Street, Pittsburgh, PA, 15222, US

(21) Appl. No.: 11/282,846

(22) Filed: Nov. 18, 2005

(51) Int. Cl. F27B 7/14

(52) U.S. Cl. 432/118; 432/103

(57) ABSTRACT

The invention comprises a heat exchanger for use in a rotary kiln having at least four legs connected to each other at a point along the axis of the kiln. Each of the legs is made from up to 70% by composition of alumina and up to 60% by composition of silicon carbide and, more particularly, where in the alumina is present in an amount of from 40 to 70% by composition and the silicon carbide is present in an amount of from 30 to 60% by composition.

### FIELD OF THE INVENTION

The present invention relates to heat exchangers for use in rotary kilns and, in particular, to a heat exchanger having plurality a legs composed of alumina and silicon carbide, and, in particular, a heat exchanger having four legs and said legs comprising up to 60% silicon carbide.

### BACKGROUND OF THE INVENTION

Rotary kilns are well known and have been used for many years. They are typically elongated cylinders that inclined to facilitate material handling and are used for processing many type of materials such as lime, dolomite, magnesite, coke and cement. It is also quite common to use pre heaters or heat exchangers in the rotary kilns. Prior art heat preheater has been disclosed in U.S. Pat. No. 2,889,143 to Reaney et al. and prior heat exchangers have been shown in U.S. Pat. No. 3,030,091 to Wicken et al., U.S. Pat. No. 3,036,822 to Andersen, U.S. Pat. No. 3,169,016 to Wicken et al., U.S. Pat. No. 3,175,815 to Wicken et al., U.S. Pat. No. 4,846,677 to Crivelli et al, U.S. Pat. No. 5,330,351 to Ransom et al., U.S. Pat. No. 6,257,878 to Marr et al., and, more recently, U.S. Pat. No. 6,688,884 to Thibault et al.

Rotary kilns typically have an interior refractory brick lining within a cylindrical steel shell exterior that has an intake end elevated above a discharge end at a small angle. The material to be treated is fed into the intake end as the shell rotates and the material is processed to the discharged end. Most kilns have at least one heat exchanger. The heat exchanger, typically is of a trefoil (three legs) construction built within the kiln along its axis some distance from the intake end. The trefoil heat exchanger divides the cross section of the kiln into three segments to enhance the heat transfer from the gas to the material and improve mixing of the material. A three-segment trefoil heat exchanger comprises three spokes or legs which extend from the axial center of the kiln to locations equally spaced around the interior circumference of the steel shell.

Because of the harsh operating conditions within a rotary kiln, heat exchangers typically encounter gas temperatures 1,500 to 2,300° F. and a highly caustic atmosphere which impose both chemical and structural stresses thereon. To withstand the various compressive forces imposed by moving material to be treated as well as the deflections inherent in the rotating kiln, the heat exchangers are usually formed from individual refractory bricks, although some have been formed in-situ from refractory materials which are cast and cured inside the kiln. Installation of conventional brick heat exchangers is labor-intensive and requires highly skilled artisans. The bricks also require complicated forms specific to a single rotary kiln size to support them during construction. Thus, brick heat exchangers are slow to install and are expensive. In-situ cast refractory heat exchangers also suffer from disadvantages such as premature wear, complicated forms and slower installation than brick. More recently, however, precast hubs and leg assemblies for the heat exchangers have been proposed (See U.S. Pat. No. 6,688,884) for use in high temperature rotary kilns. As proposed, these are heat exchangers of the trefoil type comprising three legs and a hub to which the legs are attached which is said to facilitate installation.

Notwithstanding the numerous improvements in the design and construction of heat exchangers, there continues to be a need for a less complicated and a more efficient heat exchanger that is simple to install, and can withstand the harsh operating conditions of rotary kilns for extended periods of time without premature wear.

Accordingly, it is an object of the invention to provide a quadrafoil heat exchanger that provides increased thermal efficiencies and is relatively simple to install. Most importantly, it is a further object of the present invention to provide a heat exchanger that has better wear characteristics to with stand the harsh environmental conditions and overcomes the forces inherent in rotary kilns.

### SUMMARY OF THE INVENTION

Generally, the present invention provides a heat exchanger having a plurality of precast equally offset legs designed to interlock without the need of a hub. The presently preferred embodiment of the invention provides for four legs designed to interlock with each other at a 45° angle. The legs provide a greater surface area that the prior art trefoil designs and thus a much greater thermal transfer efficiency. Typically, the invention provides a heat exchange surface that is 30% greater than the prior art.

The heat exchanger of the present invention is also lighter in weight than the prior art making it easier to install and lower reversible thermal expansion. These advantages are achieved through the use of from 40% to 70% low moisture Al₂O₃ together with from 60% to 5% SiC. A presently preferred embodiment comprises 60% Al₂O and 15% SiC. These compositions provide a 20 pound per cubic foot weight advantage over the typical prior art system.

These and other advantages of the present invention will become apparent from a perusal of the following detailed description of presently preferred embodiments of the invention taken in connection with the accompanying drawing.

### BRIEF DESCRIPTION OF THE DRAWING

FIG. 1 is a plan view of a quadra-foil, or four chamber heat exchanger of the present invention as shown positioned in a conventional rotary kiln.

### DETAILED DESCRIPTION OF PRESENTLY PREFERRED EMBODIMENTS

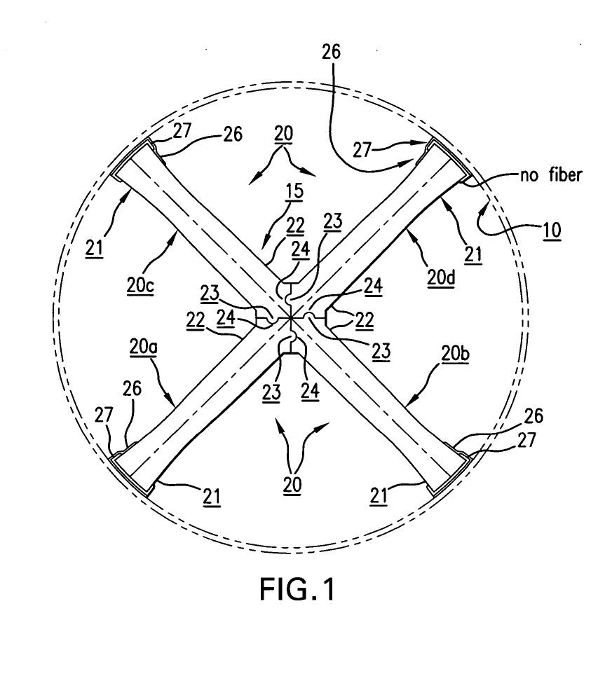

With reference to FIG. 1, the outer cylindrical shell 10 of a rotary kiln is shown with heat exchanger 15 in its presently preferred embodiment axially positioned in shell 10. Heat exchanger 15 comprises four precast legs 20 having a first end 21 adapted for mounting to shell 10 and second end 22 for interlocking contact with the corresponding ends 22 of the other legs. Ends 22 of each leg 20a, 20b, 20c and 20d comprise a tongue 23 and mating groove 24. Tongues 23 are shaped and sized to nest in associated grooves 24 of an adjacent leg to lock the legs together. As shown in FIG. 1, each leg is preferably beveled and intersects the mating legs at a 90° angle.

When installed in a kiln, a small fiber blanket 26 is interposed between shell 10 and a U-shaped, flat metal bar 27 positioned over end 21 of an associated leg 20. Bars 27 are secured, e.g. welded, to shell 10 to secure heat exchanger 15 to the rotary kiln during and after the legs are assembled therein. Preferable a fabric 28 is interposed between shell 10 and U-shaped bar 27 for thermal shock insulation Typically, the legs are sequentially positioned in shell 10 with leg 20a first, leg 20b next and legs 20c and 20d thereafter by positioning leg 20 into bar 27 and inserting the tongue 23 of second, third and fourth leg into an associated groove 24 of the adjacent leg 20.

Typically, rotary kilns may be from 150 to 750 feet in length and 5 to 30 feet in diameter. Heat exchanger 15 may comprise a number of sections located in the middle to upper section of the kiln. For example, a preferred embodiment of heat exchanger 15 comprised 12 feet in an experimental kiln. In the preferred embodiments of the invention, for shells less than 12 feet in diameter, the width of legs 20, that is, in the axial dimension of the kiln, is 10 to 15 inches and preferably 12 inches. For shells greater than 12 feet in diameter the width of legs 20 is from about 16 to 20 inches and more preferably, 18 inches.

Legs 20 are preferably formed of a monolithic refractory material having an alumina content of 40 to 70% by composition, and more preferably 45 to 60% and most preferably 60%. In addition, each leg 20 includes silicon carbide, SiC, in an amount of about 60 to 15% by composition. In one embodiment, legs 20 are formed of a dense, low cement/low alumina (45 to 60%) and 60 to 15% SiC. In a more preferred embodiment, the leg comprises a castable mixture of 60% alumina and 15% SiC. These castable legs may be reinforced with metal fibers, e.g., stainless steel, such as, 430ss, 310ss and/or 304ss fibers.

The silicon carbide used in the present invention is a particulate from −50 to −280 mesh. The use of SiC provides greater strength and nonwetting. The following table demonstrates the improvement in strength provided by the legs 20 of the present invention:

| | Test temp. | | | | Hot modulus |
|---|---|---|---|---|---|
| | 250° | Breadth, | Depth, | Max. | of rupture, |
| | for 12 hrs | inches | inches | load in lbs | psi |
| Prior Art | | | | | |
| 1 | | 2.038 | 2.008 | 311 | 397 |
| 2 | | 1.992 | 2.003 | 289 | 380 |
| 3 | | 2.043 | 1.997 | 254 | 368 |
| Legs 20 | | | | | |
| 1 | | 2.007 | 2.004 | 604 | 787 |
| 2 | | 1.985 | 2.006 | 639 | 838 |
| 3 | | 2.011 | 2.009 | 572 | 740 |

The average hot modulus of rupture for the prior art was 368 psi with a standard deviation of 36 while the average modulus of rupture for legs 20 was 788 psi with a standard deviation of 49.

While presently preferred embodiments of the invention have been shown and described, the invention maybe otherwise embodied within the scope of the following claims.

What is claimed is:

1. A heat exchanger for a rotary kiln comprising at least four legs connected to each other along an axis of said kiln, said legs being comprised of up to 70% by composition of alumina and up to 60% by composition of silicon carbide.

2. A heat exchanger for a rotary kiln as set forth in claim 1 where in said alumina is present in an amount of from 40 to 70% by composition.

3. A heat exchanger for a rotary kiln as set forth in claim 2 wherein said silicon carbide is present in an amount of from 30 to 60% by composition.

4. A heat exchanger for a rotary kiln as set forth in claim 1 wherein said silicon carbide is present in an amount of 5 to 15%.

5. A heat exchanger for a rotary kiln as set forth in claims 1, 2, 3 and 4 wherein said alumina comprises a low moisture, low cement castable alumina.

6. A heat exchanger for a rotary kiln as set forth in claim 1 wherein said alumina is present in an amount of 60% and said silicon carbide is present in an amount of 15%.

7. A heat exchanger for a rotary kiln comprising a plurality of castable leg said legs comprising alumina up to 60% by composition and silicon carbide up to 40% by composition.

8. A heat exchanger for a rotary kiln as set forth in claim 7 wherein said silicon carbide is present in an amount up to 15%.
